(19) United States
(12) Patent Application Publication
(10) Pub. No.: US 2014/0185924 A1
(43) Pub. Date: Jul. 3, 2014

(54) Face Alignment by Explicit Shape Regression

(71) Applicant: MICROSOFT CORPORATION, Redmond, WA (US)

(72) Inventors: Xudong Cao, Beijing (CN); Yichen Wei, Beijing (CN); Fang Wen, Beijing (CN); Jian Sun, Beijing (CN)

(73) Assignee: MICROSOFT CORPORATION, Redmond, WA (US)

(21) Appl. No.: 13/728,584

(22) Filed: Dec. 27, 2012

(51) Int. Cl. G06K 9/00

(52) U.S. Cl. CPC G06K 9/00281
USPC 382/159

(57) ABSTRACT

A two-level boosted regression function is learned using shape-indexed image features and correlation-based feature selection. The regression function is learned by explicitly minimizing the alignment errors over the training data. Image features are indexed based on a previous shape estimate, and features are selected based on correlation to a random projection. The learned regression function enforces non-parametric shape constraint.

### BACKGROUND

Face alignment is a term used to describe a process for locating semantic facial landmarks, such as eyes, a nose, a mouth, and a chin. Face alignment is used for such tasks as face recognition, face tracking, face animation, and 3D face modeling. As these tasks are being applied more frequently in unconstrained environments (e.g., large numbers of personal photos uploaded through social networking sites), fully automatic, highly efficient and robust face alignment methods are increasingly in demand.

Most existing face alignment approaches are optimization-based or regression-based. Optimization-based methods are implemented to minimize an error function. In at least one existing optimization-based method, the entire face is reconstructed using an appearance model and the shape is estimated by minimizing a texture residual. In this example, the learned appearance models have limited expressive power to capture complex and subtle face image variations in pose, expression, and illumination.

Regression-based methods learn a regression function that directly maps image appearance to the target output. Complex variations may be learned from large training data. Many regression-based methods rely on a parametric model and minimize model parameter errors in the training. This approach is sub-optimal because small parameter errors do not necessarily correspond to small alignment errors. Other regression-based methods learn regressors for individual landmarks. However, because only local image patches are used in training and appearance correlation between landmarks is not exploited, such learned regressors are usually weak and cannot handle large pose variation and partial occlusion.

Optimization-based methods and regression-based methods also enforce shape constraint, which is the correlation between landmarks. Most existing methods use a parametric shape model to enforce the shape constraint. Given a parametric shape model, the model flexibility is often heuristically determined.

### SUMMARY

This document describes face alignment by explicit shape regression. A vectorial regression function is learned to infer the whole facial shape from an image and explicitly minimize alignment errors over a set of training data. The inherent shape constraint is naturally encoded into the regressor in a cascaded learning framework and applied from course to fine, without using a fixed parametric shape model. In one aspect, image features are indexed according to a current estimated shape to achieve invariance. Features are selected to form a regressor based on the features' correlation to randomly projected vectors that represent differences between known face shapes and corresponding estimated face shapes. The correlation-based feature selection results in selection of features that are highly correlated to the differences between the estimated face shapes and the known face shapes, and selection of features that are highly complementary to each other.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The term “techniques,” for instance, may refer to device(s), system(s), method(s) and/or computer-readable instructions as permitted by the context above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 is a block diagram that illustrates an example process for determining a set of regressors and using those regressors to estimate a face shape in an image.

FIG. 2 is a block diagram that illustrates example components of a regressor training module as shown in FIG. 1.

FIG. 3 is a pictorial diagram that illustrates an example of globally-indexed pixels as compared to locally-indexed pixels.

FIG. 4 is a pictorial diagram that illustrates an example sequence of face shapes estimated by the two-level boosted regression module shown in FIG. 2.

FIG. 5 is a pictorial diagram that illustrates principal components of face shape that are accounted for in the early stages of an example multi-stage regression.

FIG. 6 is a pictorial diagram that illustrates principal components of face shape that are accounted for in later stages of an example multi-stage regression.

FIG. 7 is a block diagram that illustrates components of an example computing device configured to implement face alignment by explicit shape regression.

FIG. 8 is a flow diagram of an example process for learning a two-level cascaded regression framework to perform face alignment by explicit shape regression.

FIG. 9 is a flow diagram of an example process for learning a second-level boosted regression.

FIG. 10 is a flow diagram of an example process for performing face alignment by explicit shape regression to estimate a face shape in an image.

### DETAILED DESCRIPTION

Face alignment by explicit shape regression refers to a regression-based approach that does not rely on parametric shape models. Rather, a regressor is trained by explicitly minimizing the alignment error over training data in a holistic manner by which the facial landmarks are regressed jointly in a vectorial output. Each regressed shape is a linear combination of the training shapes, and thus, shape constraint is realized in a non-parametric manner. Using features across the image for multiple landmarks is more discriminative than using only local patches for individual landmarks. Accordingly, from a large set of training data, it is possible to learn a flexible model with strong expressive power.

Face alignment by explicit shape regression, as described herein, includes a two-level boosted regressor to progressively infer the face shape within an image, an indexing method to index pixels relative to facial landmarks, and a correlation-based feature selection method to quickly identify a fern to be used as a second-level primitive regressor.

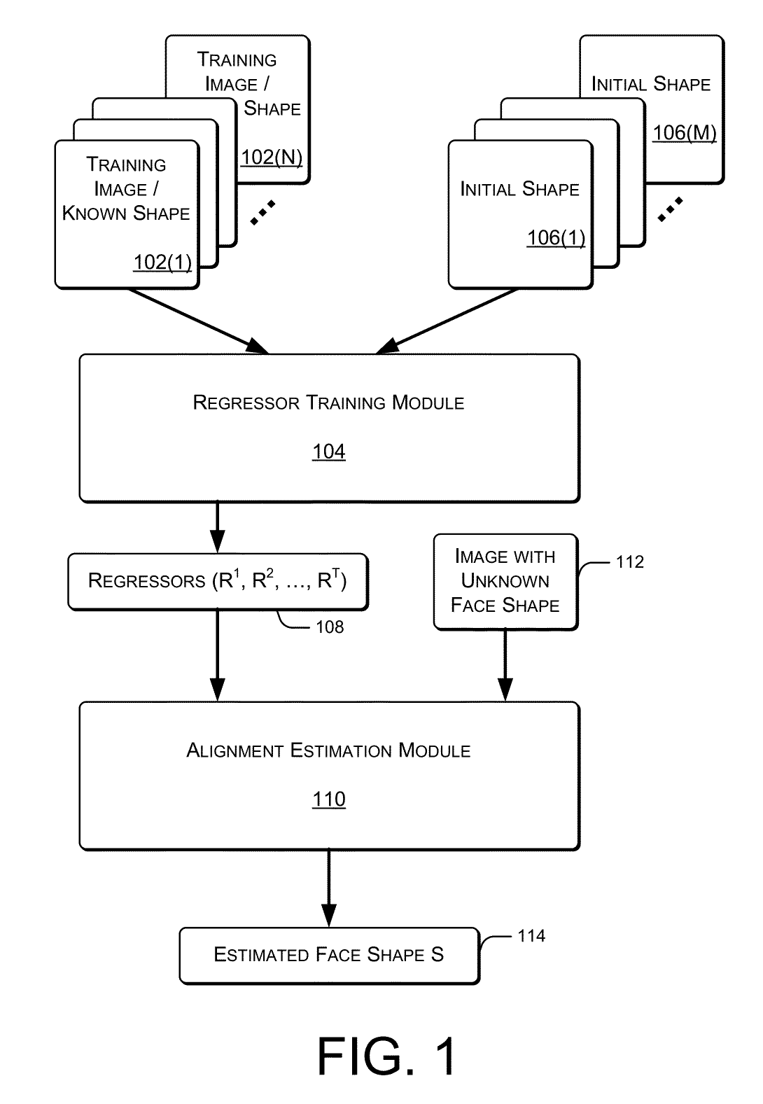

FIG. 1 illustrates an example process for determining a set of regressors and using those regressors to estimate a face shape in an image. According to the face alignment by explicit shape regression techniques described herein, a set of training images 102(1)-102(N), each having a known face shape, is input to a regressor training module 104. A set of initial shapes 106(1)-106(M) are also input to the regressor training module.

Regressor training module 104 processes each training image and corresponding known face shape 102 with an initial shape 106 to learn a set of regressors 108, which are output from the regressor training module 104.

The set of regressors 108 are then input to the alignment estimation module 110. Using the set of regressors 108, the alignment estimation module 110 is configured to estimate a face shape for an image having an unknown face shape 112. An estimated face shape 114, is output from the alignment estimation module 110.

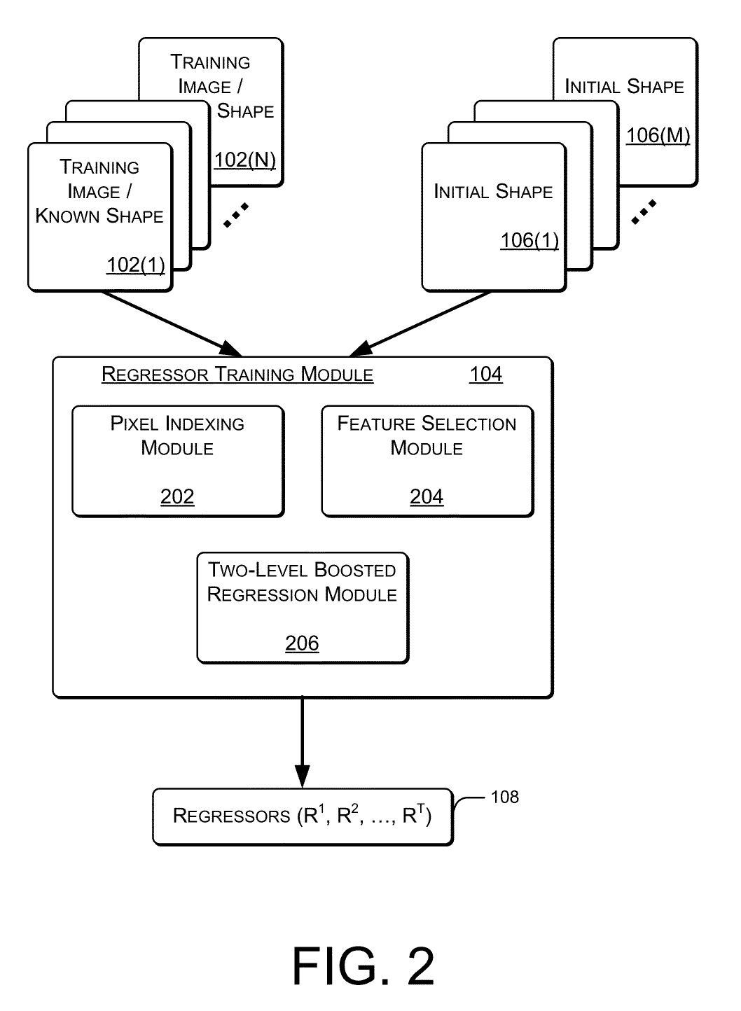

FIG. 2 illustrates example components of a regressor training module as shown in FIG. 1. In the illustrated example, regressor training module 104 includes a pixel indexing module 202, a feature selection module 204, and a two-level boosted regression module 206.

Pixel indexing module 202 is configured to determine a number of features for a given image. In the described implementation, a feature is a number that represents the intensity difference between two pixels in an image. In an example implementation, each pixel is indexed relative to the currently estimated shape, rather than being indexed relative to the original image coordinates. This leads to geometric invariance and fast convergence in boosted learning.

Features can vary significantly from one image to another based on differences in scale or rotation. To achieve feature invariance against face scales and rotations, the pixel indexing module first computes a similarity transform to normalize a current shape to a mean shape. In an example implementation, the mean shape is estimated by performing a least squares fitting of all of the facial landmarks. Example facial landmarks may include, but are not limited to, an inner eye corner, an outer eye corner, a nose tip, a chin, a left mouth corner, a right mouth corner, and so on.

While each pixel may be indexed using global coordinates (x, y) with reference to the currently estimated face shape, a pixel at a particular location with regard to a global coordinate system may have different semantic meanings across multiple images. Accordingly, in the techniques described herein, each pixel is indexed by local coordinates (δx, δy) with reference to a landmark nearest the pixel. This technique maintains greater invariance across multiple images, and results in a more robust algorithm.

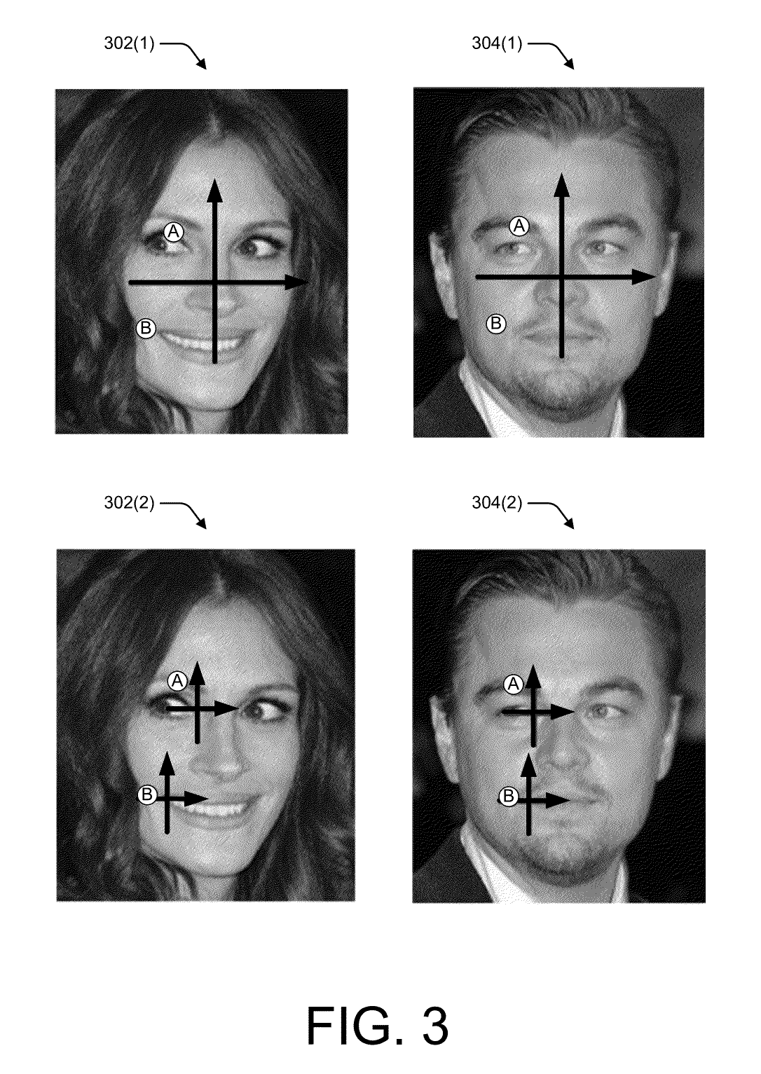

FIG. 3 illustrates an example of globally-indexed pixels as compared to locally-indexed pixels. In the illustrated example, two images, image 302 and image 304, having similar scale and face position are shown. A global coordinate system is shown overlaid on image 302(1) and image 304(1). Pixel “A” is show in the upper left quadrant of the coordinate system and pixel “B” is shown in the lower left quadrant of the coordinate system. Pixels “A” and “B” in image 302(1) have the same coordinates as pixels “A” and “B” in image 304(1). However, as illustrated, the pixels do not reference the same facial landmarks in the two images. For example, in image 302(1), pixel “A” is along the subject's upper eyelashes, while in image 304(1), pixel “A” is along the subject's eyebrow. Similarly, in image 302(1), pixel “B” is near the corner of the subject's mouth, while in image 304(1), pixel “B” is further away from the subject's mouth, falling more along the subject's cheek.

In contrast, images 302(2) and 304(2) are shown each with two local coordinate systems having been overlaid. In each of these images, the local coordinate systems are defined such that the origin of each coordinate system corresponds to a particular facial landmark. For example, the upper coordinate system in both image 302(2) and image 304(2) is overlaid with its origin corresponding to the inner corner of the left eye. Similarly, the lower coordinate system is overlaid with its origin corresponding to the left corner of the mouth. Pixel “A” in image 302(2) is defined with reference to the upper coordinate system that is originated at the inner corner of the left eye, and has the same coordinates as pixel “A” in image 304(2). Similarly, pixel “B” in image 302(2) is defined with reference to the lower coordinate system that is originated at the left corner of the mouth, and has the same coordinates as pixel “B” in image 304(2).

Based on the local coordinate systems, pixels “A” and “B” in images 302(2) and 304(2) reference similar facial landmarks. For example, in both images, pixel “A” falls within the subject's eyebrow and pixel “B” falls just to the left of the corner of the subject's mouth.

Referring back to FIG. 2, as described above, pixel indexing module 202 is configured to determine a number of features for a given image. In an example implementation, after generating local coordinate systems based on facial landmarks, the pixel indexing module 202 randomly samples P pixels from the image. The intensity difference is calculated for each pair of pixels in the set of P pixels, resulting in P² features.

Feature selection module 204 is configured to select F features from the P² features that are determined by the pixel indexing module 202. The features, F, selected by feature selection module 204 will constitute a fern, which will then be used by the two-level boosted regression module as a second-level primitive regressor.

Two-level boosted regression module 206 is configured to learn a vectorial regression function, R^{t}, to update a previously-estimated face shape, S^{t-1}, to a new estimated face shape, S^{t}. The two-level boosted regression module 206 learns the first-level regressor, R^{t}, based on the image, I, and a previous estimated face shape, S^{t-1}. Each R^{t}, is constructed from the primitive regressor ferns generated by the features selection module 204, which are based on features indexed relative to the previous estimated face shape, S^{t-1}.

The two-level boosted regressor includes early regressors, which handle large shape variations, and are very robust, and later regressors, which handle small shape variations, and are very accurate. Accordingly, the shape constraint is automatically and adaptively enforced from coarse to fine.

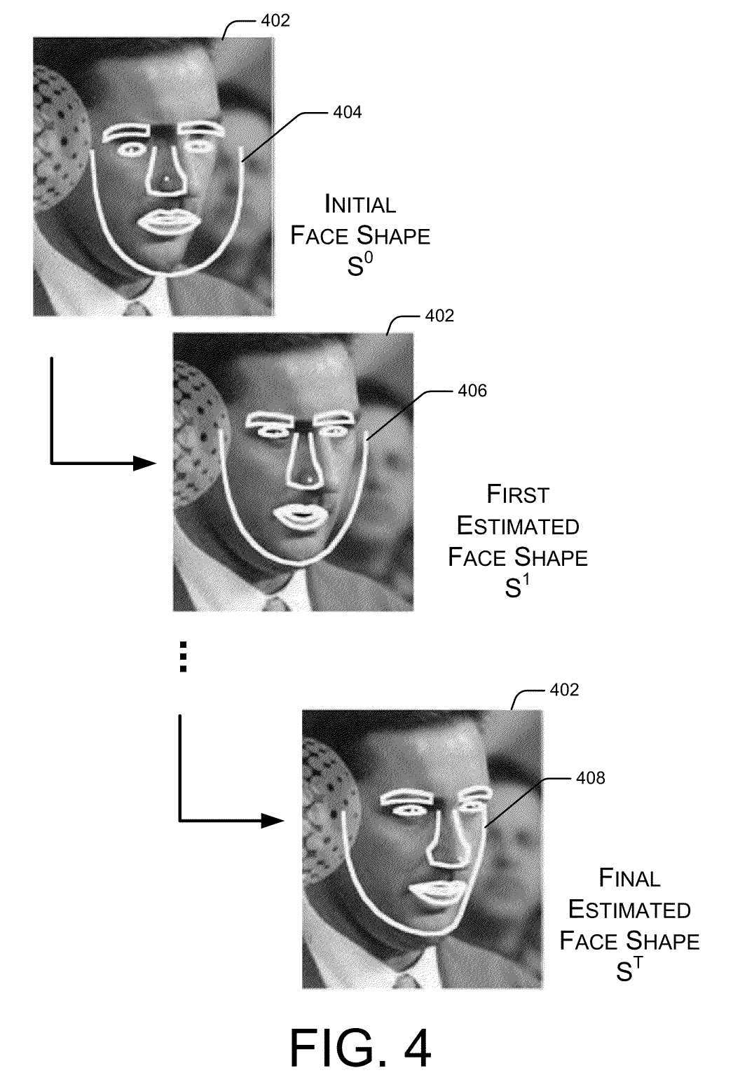

FIG. 4 illustrates an example sequence of face shapes estimated by the two-level boosted regression module 206. FIG. 4 illustrates an example image 402 for which a face shape is to be estimated. As described above with reference to FIG. 1, an initial face shape S⁰ is selected. The initial face shape 404 is typically quite different from the actual face shape, but serves as a starting point for the two-level boosted regression module 206. A sequence of successive face shape estimates are then generated, each more closely resembling the actual face shape than the previous estimate. As shown in FIG. 4, the first estimated face shape 406 shows a face that is turned slightly to the right as compared to the initial face shape 404. Additional face shapes are then estimated (not shown), until a final estimated face shape 408 is generated.

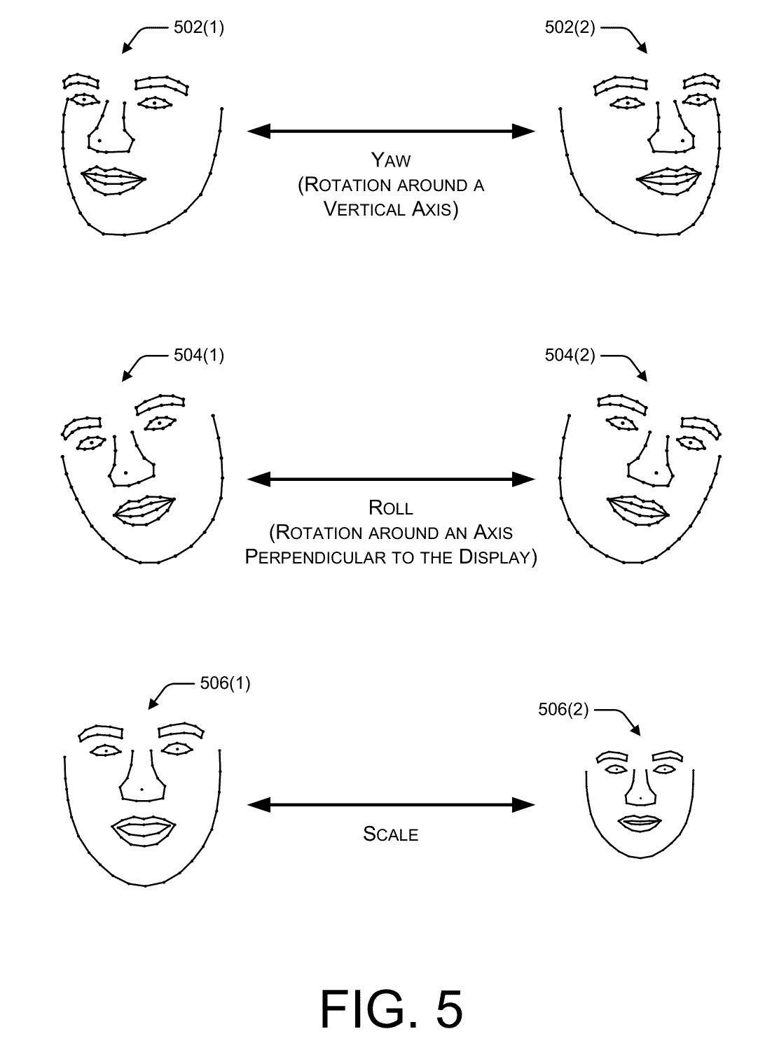

FIG. 5 illustrates principal components of face shape that are accounted for in the early stages of an example multi-stage regression. As mentioned above, the early regressors handle large shape variations, while the later regressors handle small shape variations. In the illustrated example, three principal components, yaw, roll, and scale, are coarse face shape differences that are handled by the early regressors.

Face shapes 502(1) and 502(2) illustrate a range of differences in yaw, which accounts for rotation around a vertical axis. In other words, the shape of a face in an image will differ as illustrated by example face shapes 502(1) and 502(2) depending on a degree to which the person's head is turned to the left or to the right.

Face shapes 504(1) and 504(2) illustrate a range of differences in roll, which accounts for rotation around an axis perpendicular to the display. In other words, the shape of a face in an image will differ as illustrated by example face shapes 504(1) and 504(2) depending on a degree to which the person's head is tilted to the left or to the right.

Face shapes 506(1) and 506(2) illustrate a range of differences in scale, which accounts for an overall size of the face. In other words, the shape of a face in an image will differ as illustrated by example face shapes 506(1) and 506(2) depending on a perceived distance between the camera and the person.

FIG. 5 illustrates just three examples of coarse shape variations that may be handled by early stage regressors. However, the early stage regressors may handle any number of additional or different coarse shape variations which may not be shown in FIG. 5.

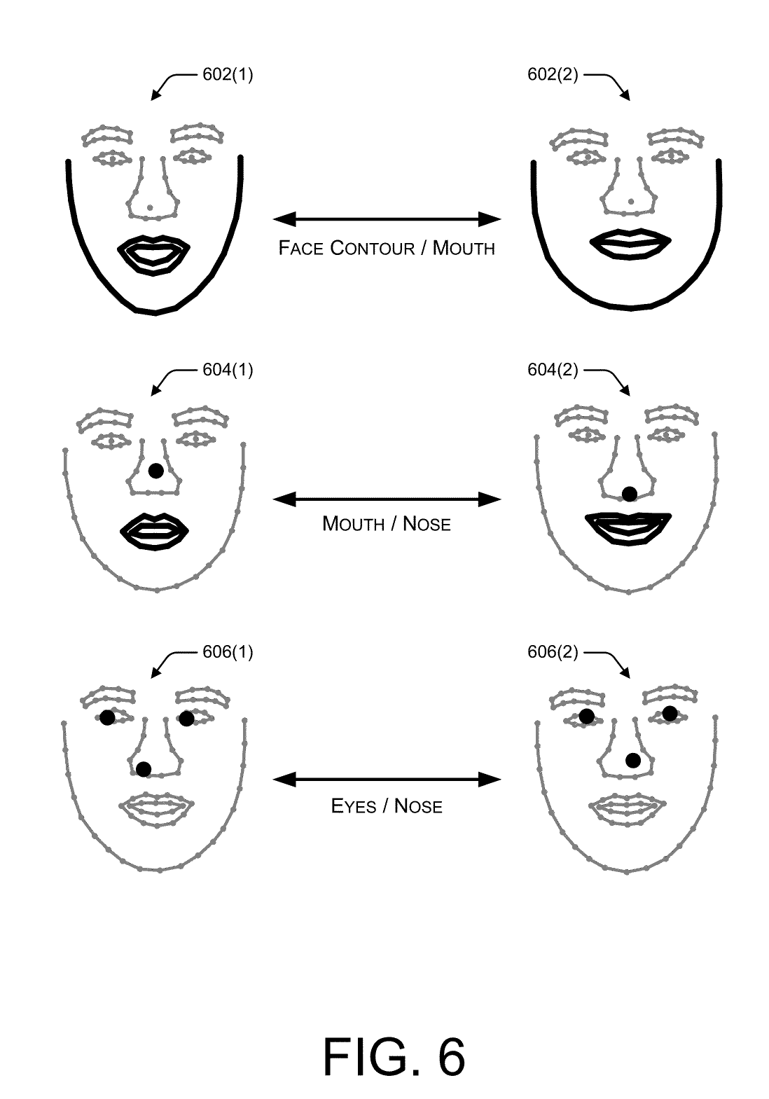

FIG. 6 illustrates principal components of face shape that are accounted for in later stages of an example multi-stage regression. As mentioned above, the early regressors handle large shape variations, while the later regressors handle small shape variations. In the illustrated example, three principal components, reflecting subtle variations in face shape, are handled by the later regressors.

Example face shapes 602(1) and 602(2) illustrate a range of subtle differences in the face contour and mouth shape; example face shapes 604(1) and 604(2) illustrate a range of subtle differences in the mouth shape and nose tip; and example face shapes 606(1) and 606(2) illustrate a range of subtle differences in the position of the eyes and the tip of the nose. FIG. 6 illustrates just three examples of subtle shape variations that may be handled by late stage regressors. However, the late stage regressors may handle any number of additional or different subtle shape variations which may not be shown in FIG. 6.

### Example Computing Device

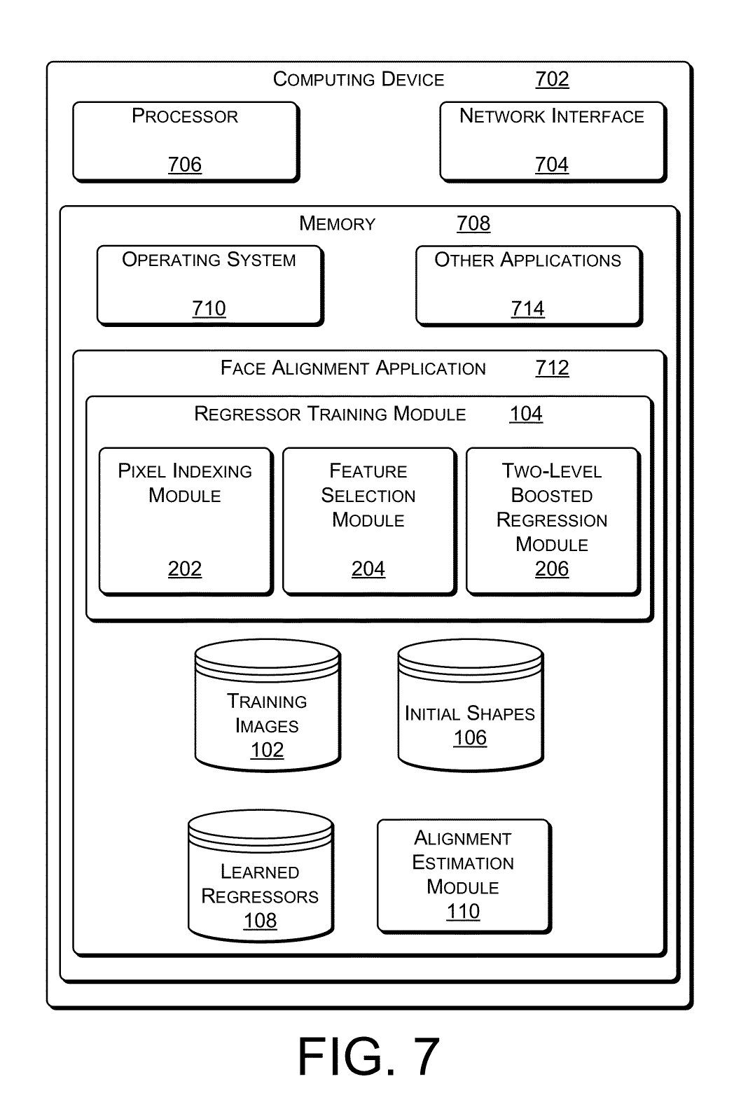

FIG. 7 illustrates components of an example computing device 702 configured to implement the face alignment by explicit shape regression techniques described herein. Example computing device 702 includes one or more network interfaces 704, one or more processors 706, and memory 708. Network interface 704 enables computing device 702 to communicate with other devices over a network, for example, to receive images for which face alignment is to be performed.

An operating system 710, a face alignment application 712, and one or more other applications 714 are stored in memory 708 as computer-readable instructions, and are executed, at least in part, on processor 706.

Face alignment application 712 includes a regressor training module 104, training images 102, initial shapes 106, learned regressors 108, and an alignment estimation module 110. As described above, the regressor training module 104 includes a pixel indexing module 202, a feature selection module 204, and a two-level boosted regression module 206.

In an example implementation, training images 102 are maintained in a data store. Each training image includes an image, I, and a known shape, g. Initial shapes 106 include any number of shapes to be used as initial shape estimates during a training phase to learn the regressors, or when estimating a face shape for a non-training image. In an example implementation, initial shapes 106 are randomly sampled from a set of images with known face shapes. This set of images may be different from the set of training images. Alternatively, the initial shapes 106 may be mean shapes calculated from any number of known shapes. A variety of other techniques may be used to establish a set of one or more initial shapes 106. The initial shapes 106 may be used by the two-level boosted regression module 206 when learning the regressors, and may also be used by the alignment estimation module 110 when estimating a shape for an image with no known face shape.

Learned regressors 108 are output from the two-level boosted regression module 206. The learned regressors 108 are maintained and subsequently used by alignment estimation module 110 to estimate a shape for an image with no known face shape.

Although illustrated in FIG. 7 as being stored in memory 708 of computing device 702, face alignment application 712, or portions thereof, may be implemented using any form of computer-readable media that is accessible by computing device 702. Furthermore, in alternate implementations, one or more components of operating system 710, face alignment application 712, and other applications 714 may be implemented as part of an integrated circuit that is part of, or accessible to, computing device 702.

Computer-readable media includes at least two types of computer-readable media, namely computer storage media and communications media.

Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store information for access by a computing device.

In contrast, communication media may embody computer readable instructions, data structures, program modules, or other data in a modulated data signal, such as a carrier wave. As defined herein, computer storage media does not include communication media.

### Example Operation

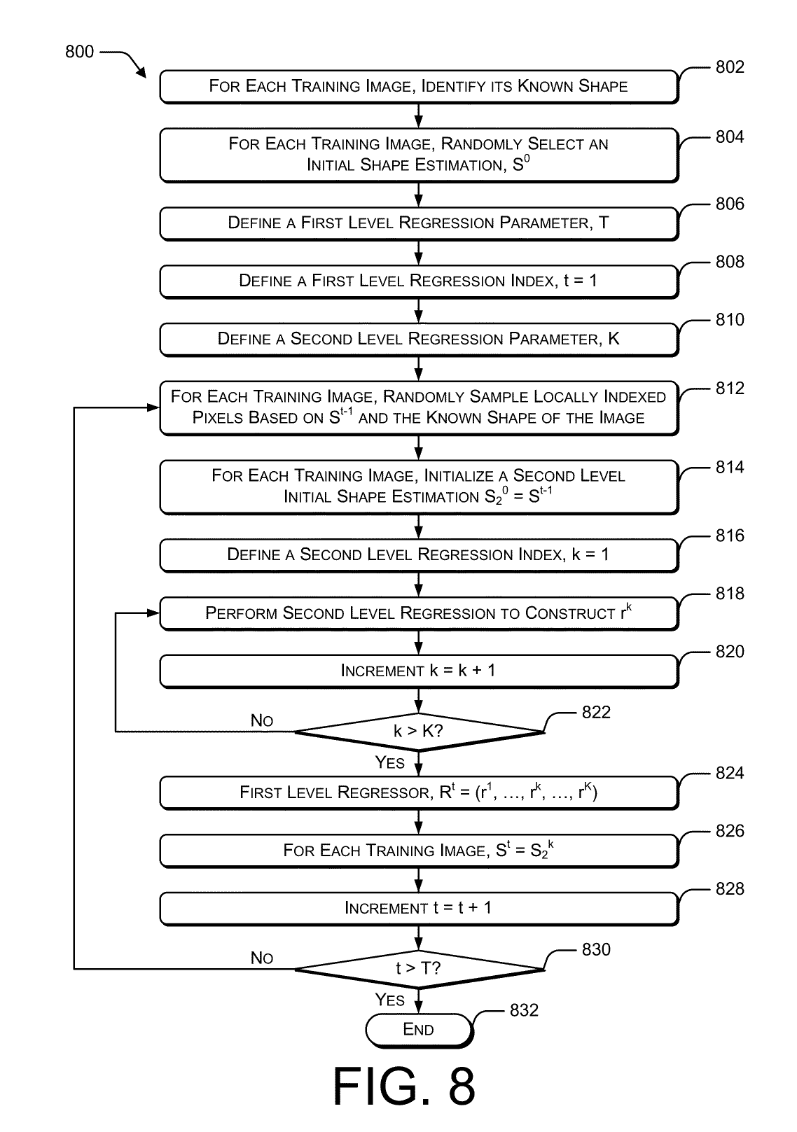

FIGS. 8-10 illustrate example processes for learning a regression framework and applying the regression framework for performing face alignment by explicit shape regression. The processes are illustrated as collections of blocks in logical flow graphs, which represent sequences of operations that can be implemented in hardware, software, or a combination thereof. In the context of software, the blocks represent computer-executable instructions stored on one or more computer storage media that, when executed by one or more processors, cause the processors to perform the recited operations. Note that the order in which the processes are described is not intended to be construed as a limitation, and any number of the described process blocks can be combined in any order to implement the processes, or alternate processes. Additionally, individual blocks may be deleted from the processes without departing from the spirit and scope of the subject matter described herein. Furthermore, while the processes are described with reference to the computing device 702 described above with reference to FIG. 7, other computer architectures may implement one or more portions of the described processes, in whole or in part.

Regressors are learned during a training process using a large number of images (e.g., training images 102). For each image in the training data, the actual face shape is known. For example, the face shapes in the training data may be labeled by a human.

A face shape, S, is defined in terms of a number, L, of facial landmarks, each represented by an x and y coordinate, such that:

S=[x₁,y₁, . . . ,x_{L},y_{L}].

Given an image of a face, the goal of face alignment is to estimate a shape, S, that is as close as possible to the true shape, Ŝ, thereby minimizing the value of:

∥S−Ŝ∥₂ (1)

FIG. 8 illustrates an example process 800 for learning a two-level cascaded regression framework to perform face alignment by explicit shape regression.

At block 802, for each training image, I, its known shape, Ŝ, is identified. For example, two-level boosted regression module 206 selects training images and corresponding known shapes from training images 102.

At block 804, for each training image, an initial shape estimation, S⁰, is selected. For example, two-level boosted regression module 206 selects one or more shapes from initial shapes 106.

At block 806, a first level regression parameter, T, is defined. T may be defined as any number. However, selection of a particular value for T may impact both computational cost and accuracy. In an example implementation, T is defined such that T=10.

At block 808, a first level regression index, t, is initialized to t=1. The first level regression index is configured to increment from 1 to T.

At block 810, a second level regression parameter, K, is defined. K may be defined as any number. However, selection of a particular value for K may impact both computational cost and accuracy. In an example implementation, K is defined such that K=500.

At block 812, a number, P, of pixels, which are locally indexed, are randomly sampled from each training image based on estimated shape S^{t-1} and the known shape of each training image. Locally indexed pixels are described above with reference to pixel indexing module 202 and FIG. 3. The number, P, of locally indexed pixels selected from each training image can affect both computational cost and accuracy. In an example implementation, P=400. Pixel-difference features are calculated using the P pixels that have been randomly sampled from each training image. As described above, a feature is calculated as the intensity difference between two pixels. Thus, calculating a feature using each possible pair of pixels in the P sampled pixels results in P² features for each training image.

At block 814, for each training image, two-level boosted regression module 206 initializes a second level initial shape estimation, S₂⁰, such that S₂⁰=S^{t-1}.

At block 816, a second level regression index, k, is initialized to k=1. The second level regression index is configured to increment from 1 to K.

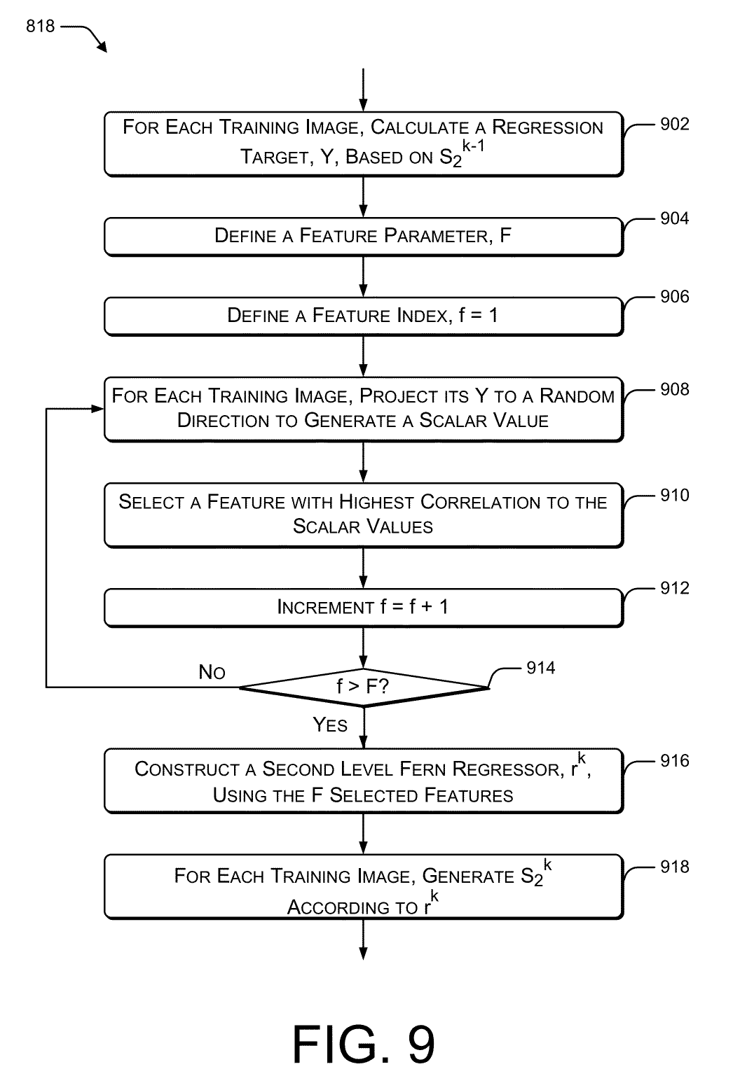

At block 818, a second level regression is performed to construct a second level regressor, r^{k}. The second level regression is described in further detail below with reference to FIG. 9.

At block 820, the second level regression index is incremented such that k=k+1.

At block 822, a determination is made as to whether or not a sufficient number of second level regressors have been constructed. If k<=K (the “No” branch from block 822), the processing continues as described above with reference to block 818.

At block 824, the first-level regressor, R^{t}, is constructed such that R^{t}=(r¹, . . . , r^{k}, . . . , r^{K}).

At block 826, for each training image, a new shape estimation, S^{t}, is calculated such that S^{t}=S₂^{k}.

At block 828, the first level regression index, t, is incremented such that t=t+1.

At block 830, a determination is made as to whether or not t is now greater than T. If t<=T (the “No” branch from block 830), then processing continues as described above with reference to block 812. However, if t>T, indicating that each of regressors R¹-R^{T} have been learned (the “Yes” branch from block 830), then processing is complete, as indicated by block 832.

As illustrated in FIG. 8, using boosted regression, T weak regressors (R¹, . . . , R^{t}, . . . , R^{T}) are combined in an additive manner. For a given image, I, and an initial estimated face shape S⁰, each regressor computes a shape increment vector OS from image features and then updates the face shape, in a cascaded manner such that:

S^{t}=S^{t-1}+R^{t}(1,S^{t-1}),t=1, . . . ,T (2)

As described below with reference to FIG. 9, a second level boosted regression is performed to learn each R^{t} using features that are indexed relative to the previous shape estimation, S^{t-1}.

For example, given N training images with known face shapes, {(Iᵢ, Ŝᵢ)}ᵢ₌₁^{N}, where Iᵢ is the i^{th} training image and Ŝᵢ is the known face shape of the i^{th} training image, the regressors (R¹, . . . , R^{t}, . . . , R^{T}) are sequentially learned until the training error no longer decreases. That is, each regressor R^{t} is learned by explicitly minimizing the sum of alignment errors such that:

R^{t}=arg min_{R}Σᵢ₌₁^{N}∥Ŝᵢ−(Sᵢ^{t-1}+R(Iᵢ,Sᵢ^{t-1}))∥ (3)

where Sᵢ^{t-1} is the shape estimated in the previous stage.

FIG. 9 illustrates an example process 818 for learning a second-level boosted regression.

As discussed above, regressing the entire shape, which may be as large as dozens of landmarks, is a difficult task, especially in the presence of large image appearance variations and rough shape initializations. To address this challenge, each weak regressor, R^{t}, is learned by a second level boosted regression such that R^{t}=(r¹, . . . , r^{k}, . . . , r^{K}). In this second level, the shape-indexed image features are fixed, such that they are indexed only relative to S^{t-1}.

At block 902, for each training image, a regression target, Y, is calculated such that

Y=Ŝ−S₂^{k-1}.

That is, Y is defined as the difference between the known face shape of the training image and the current estimated face shape.

At block 904, a feature parameter, F, is defined. F represents a number of features to be selected for use as a fern regressor. F may be defined as any number. However, selection of a particular value for F may impact both computational cost and accuracy. In an example implementation, F is defined such that F=5.

At block 906, a feature index, f is initialized to f=1. The feature index is configured to increment from 1 to F.

At block 908, for each training image, the regression target, Y, is projected to a random direction to generate a scalar value.

At block 910, a particular feature is selected from the P² features calculated for each training image, such that the selected feature has the highest correlation of the calculated features to the scalar values generated at block 908.

At block 912, the feature index is incremented such that f=f+1.

At block 914, a determination is made as to whether or not a sufficient number of features have been selected. If f<=F (the “No” branch from block 914), the processing continues as described above with reference to block 908, to select another feature.

At block 916, when it is determined that f>F, indicating that the desired number of features have been selected (the “Yes” branch from block 914), a fern regressor, r^{k}, is constructed using the F selected features.

At block 918, for each training image, a new second level estimated face shape, S₂^{k}, is generated according to r^{k}. Processing then continues as described above with reference to block 820 of FIG. 8.

As described with reference to FIG. 9, the second level boosted regression includes the construction of fern regressors. To quickly identify good candidate ferns, two properties are considered based on the correlation between the features and the regression target, Y, where Y is a vector that is defined as the difference between a known face shape of a training image and a current estimated face shape (See block 902). First, the degree to which each feature in the candidate fern is discriminative to Y; and second, the correlation between the features in the candidate fern. In a good candidate fern, based on the first property, each feature in the fern will be highly discriminative to Y, and based on the second property, the correlation between the features will be low, thus the features will be complementary when composed.

The random projection (see block 908 of FIG. 9) serves two purposes. First, it can preserve proximity such that features that are correlated to the projection are also discriminative to Y. Second, the multiple random projections have a high probability of having low correlation with one another; thus, the features that are selected based on high correlation with the projections are likely to be complementary.

As described herein, in an example implementation, each primitive regressor, r, is implemented as a fern. A fern is a composition of F features (e.g., F=5) and thresholds that divide the feature space (and all training samples) into 2^{F} bins. Each bin, b, is associated with a regression output δS_{b} that minimizes the alignment error of training samples Ω_{b} falling into the bin such that:

δS_{b}=arg min_{δS}Σ_{iεΩ}_{_{b}}∥Ŝᵢ−(Sᵢ+δS)∥ (4)

where Sᵢ denotes the shape estimated in the previous step.

The solution to equation (4) is the mean of shape differences:

$$δ {S}_{b} = \frac{{\sum }_{i ∈ {Ω}_{b}} ( {\hat{S}}_{i} - {S}_{i} )}{\vert {Ω}_{b} \vert} \qquad ( 5 )$$

In an example implementation, over-fitting may occur if there is insufficient training data in a particular bin. To account for such over-fitting, a free shrinkage parameter, β, is used. When the bin has sufficient training samples, the shrinkage parameter has little effect, but when there is insufficient training data, the estimation is adaptively reduced according to:

$$δ {S}_{b} = \frac{1}{1 + β / \vert {Ω}_{b } \vert} \frac{{\sum }_{i ∈ {Ω}_{b}} ( {\hat{S}}_{i} - {S}_{i} )}{\vert {Ω}_{b} \vert} \qquad ( 6 )$$

The number, F, of features in a fern and the shrinkage parameter, β, adjust the trade-off between fitting power in training and generalization ability when testing. In an example implementation, F=5 and β=1000.

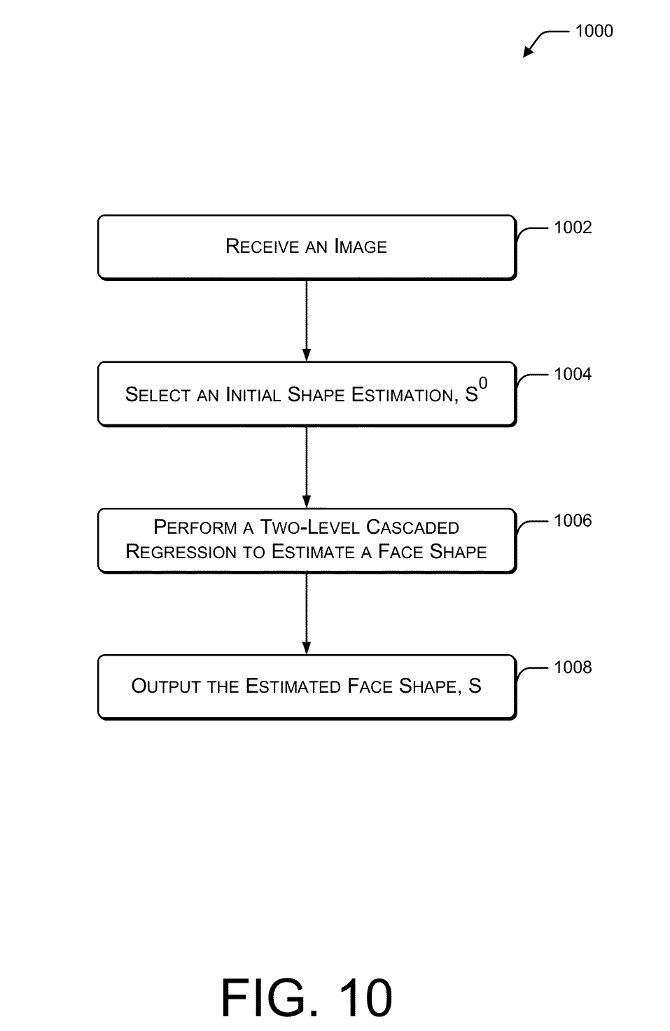

FIG. 10 illustrates an example process 1000 for performing face alignment by explicit shape regression to estimate a face shape in an image.

At block 1002, an image is received. For example, as illustrated in FIG. 1, alignment estimation module 110 receives image 112.

At block 1004, an initial shape estimation, S⁰, is selected. For i example, alignment estimation module 110 selects an initial shape from initial shapes 106.

At block 1006, a two-level cascaded regression is performed to estimate a face shape. For example, alignment estimation module 110 applies learned regressors 108 to image 112 to determine an estimated face shape 114.

At block 1008, the estimated face shape is output. For example, the alignment estimation module 110 returns the estimated face shape to a calling application.

### Non-Parametric Shape Constraint

As described above, shape constraint is defined as the correlation between landmarks. According to the explicit shape regression technique described herein, the correlation between landmarks is preserved by learning a vector regressor and explicitly minimizing the shape alignment error (as given in Equation (1)). Because each shape update is additive and each shape increment is the linear combination of certain training shapes, {Ŝᵢ} (as shown in Equations (5) and (6)), the final regressed shape, S, can be expressed as the initial shape, S⁰, plus the linear combination of all training shapes, or:

S=S⁰+Σᵢ₌₁^{N}wᵢŜᵢ (7)

Accordingly, as long as the initial shape, S⁰, is selected from the training shapes, the regressed shape is constrained to reside in the linear subspace constructed by all of the training shapes. Furthermore, any intermediate shape in the regression also satisfies the constraint. According to the techniques described herein, rather than being heuristically determined, the intrinsic dimension of the subspace is adaptively determined during the learning phase.

### CONCLUSION

Although the subject matter has been described in language specific to structural features and/or methodological operations, it is to be understood that the subject matter defined in the appended claims is not necessarily limited to the specific features or operations described. Rather, the specific features and acts are disclosed as example forms of implementing the

What is claimed is:

1. A method comprising:
receiving a plurality of training images, wherein each training image has an associated known face shape; and
learning regressors according to a two-level regression framework based on the plurality of training images, wherein learning the regressors includes:
learning a series of first-level regressors to compute a sequence of estimated face shapes for each training image, wherein an estimated face shape is computed based on at least features of a previous estimated face shape and features of the training image, wherein learning each first-level regressor includes:
for each training image, sampling pixels that are locally indexed based on facial landmarks and the previous estimated face shape;
calculating features based on the pixels that are sampled; and
learning a series of second-level regressors, wherein learning each second-level regressor includes:
selecting one or more features from the features that are calculated, wherein selecting the one or more features comprises selecting features that have a high correlation to a regression target and a low feature-to-feature correlation; and
constructing a fern regressor using the features that are selected.

2. A method as recited in claim 1, wherein selecting the one or more features comprises:
for each training image, calculating a regression target as a difference between the known face shape associated with the training image and the previous estimated face shape;
for each training image, calculating a scalar value by projecting the regression target in a random direction; and
selecting a feature having a highest correlation to the scalar values that are calculated.

3. A method as recited in claim 1, wherein learning each second-level regressor further includes:
determining a current second level shape estimation; and
calculating a new second level shape estimation according to the fern regressor that is constructed.

4. A method as recited in claim 3, wherein learning each first-level regressor further includes setting a next estimated face shape in the sequence of estimated face shapes equal to the new second level shape estimation that is calculated based on a last second level regressor learned in the series of second level regressors.

5. A method as recited in claim 1, further comprising:
receiving an image having no known face shape; and
using the regressors that are learned according to the two-level regression framework to estimate a face shape for the image that is received.

6. One or more computer readable media encoded with computer-executable instructions that, when executed, configure a computer system to perform a method as recited in claim 1.

7. A system comprising:
a processor;
a memory;
a two-level boosted regression framework, stored in the memory and executed by the processor to learn a regression function to estimate a face shape in an image, wherein the two-level boosted regression framework maintains correlations between facial landmarks without using a parametric shape model.

8. A system as recited in claim 7, wherein the two-level boosted regression framework comprises a first level regressor that is learned by minimizing an alignment error over a set of training images.

9. A system as recited in claim 7, wherein the two-level boosted regression framework comprises a first level regressor that is learned based on features indexed relative to a training image and features indexed relative to a previous estimated shape.

10. A system as recited in claim 7, wherein the two-level boosted regression framework comprises a second level regressor that is learned based on image features that are indexed relative only to a previous face shape estimate.

11. A system as recited in claim 10, wherein the image features are selected from a plurality of image features such that the image features that are selected have a high correlation to a random projection.

12. A system as recited in claim 10, wherein the image features are selected from a plurality of image features such that correlations between the image features that are selected are low.

13. A system as recited in claim 10, wherein the image features are indexed relative to local facial landmarks.

14. A system as recited in claim 10, wherein the image features each represent an intensity difference between two pixels.

15. A system as recited in claim 7, further comprising an alignment estimation module to use the regression function to estimate a face shape in an image.

16. A method comprising:
identifying a plurality of image features from a plurality of training images, wherein each training image has a known face shape;
for each training image, calculating a regression target vector as a difference between the known face shape of the training image and a currently estimated face shape;
selecting one or more image features of the plurality of image features based on correlations between the image features and the regression target vectors that are calculated; and
constructing a regressor using the image features that are selected.

17. A method as recited in claim 16, wherein identifying the plurality of image features comprises:
randomly sampling a plurality of pixels in each training image; and
calculating a plurality of image features based on the plurality of pixels.

18. A method as recited in claim 17, wherein each image feature is calculated as an intensity difference between two pixels.

19. A method as recited in claim 16, wherein selecting the one or more image features of the plurality of image features based on correlations between the image features and the regression target vectors for each training image comprises:
for each training image, projecting the regression target vector in a random direction to produce scalar values, each scalar value corresponding to a regression target vector; and
selecting an image feature having a highest correlation to the scalar values.

20. A method as recited in claim 16, further comprising:
receiving an image; and
using the regressor to estimate a face shape associated with the image.
